(19) United States
(12) Patent Application Publication
(10) Pub. No.: US 2014/0001366 A1
(43) Pub. Date: Jan. 2, 2014

(54) RADIOLOGICAL IMAGE DETECTION APPARATUS

(71) Applicant: FUJIFILM Corporation, Tokyo (JP)

(72) Inventors: Yoichi NISHIDA, Ashigarakami-gun (JP); Yukinori NAKAMURA, Ashigarakami-gun (JP); Akihiro ANZAI, Ashigarakami-gun (JP)

(21) Appl. No.: 13/911,140

(22) Filed: Jun. 6, 2013

(30) Foreign Application Priority Data
Jun. 28, 2012 (JP) 2012-145285

(51) Int. Cl. G01T 1/20

(52) U.S. Cl. CPC G01T 1/2006
USPC 250/366

(57) ABSTRACT

There is provided a radiological image detection apparatus having excellent sensitivity. A scintillator has a plurality of columnar crystals formed of thallium-activated cesium iodide, and converts X-rays into visible light and emits the visible light from the distal end of the columnar crystal. A photoelectric conversion panel generates electric charges by detecting the visible light emitted from the scintillator. The molar ratio of thallium to cesium iodide in the scintillator is in a range of 0.1 mol % to 0.55 mol %. The half width of the rocking curve of the (200) plane of the columnar crystal is equal to or less than 3°.

### BACKGROUND OF THE INVENTION

1. Field of the Invention

The present invention relates to a radiological image detection apparatus that detects a radiological image.

2. Description of the Related Art

In recent years, in the medical field, a radiological image detection apparatus that detects a radiation (for example, X-rays), which is emitted from a radiation source toward an imaging region of a patient and is transmitted through the imaging region, and converts the radiation into electric charges and generates image data indicating a radiological image of the imaging region based on the electric charges is used to perform diagnostic imaging. There are a direct conversion type radiological image detection apparatus, which directly converts a radiation into electric charges, and an indirect conversion type radiological image detection apparatus, which converts a radiation into visible light first and converts the visible light into electric charges.

The indirect conversion type radiological image detection apparatus has a scintillator (phosphor layer) that converts a radiation into visible light and a photoelectric conversion panel that detects visible light and converts the visible light into electric charges. Cesium iodide (CsI) or gadolinium oxide sulfur (GOS) is used for the scintillator.

In the case of cesium iodide, the manufacturing cost is high compared with GOS. However, since cesium iodide has high conversion efficiency from a radiation to visible light and has a columnar crystal structure, the SN ratio of image data is improved by the light guide effect. Accordingly, cesium iodide is especially used as a scintillator of a high-end radiological image detection apparatus. However, since luminous efficiency is low with only cesium iodide, an improvement in luminous efficiency is achieved by adding an activator, such as thallium (Tl), to acquire thallium-activated cesium iodide (CsI:Tl).

In a scintillator formed of such a crystal, the sensitivity is theoretically improved as the thickness increases. In practice, however, if the thickness increases to a certain level or more, attenuation or scattering when visible light generated in the scintillator passes through the scintillator itself becomes large. As a result, sufficient sensitivity cannot be obtained. For this reason, increasing the crystallinity of the scintillator to a predetermined reference value or more based on the X-ray diffraction spectrum has been proposed (refer to WO2009/041169A and WO2011/089946A).

WO2009/041169A discloses that the half width of the X-ray diffraction spectrum of the (200) plane, among the crystal lattice planes, is set to be equal to or less than 0.4°. WO2011/089946A discloses that the degree of orientation based on the X-ray diffraction spectrum of the (200) plane is set to be within the range of 80% to 100%.

### SUMMARY OF THE INVENTION

However, the X-ray diffraction method disclosed in WO2009/041169A and WO2011/089946A is a θ-2θ method, and is for determining the orientation in regards to the direction in which the crystals are aligned. Accordingly, since the degree of orientation of crystals with very high orientation cannot be evaluated, there is a problem in that the crystallinity cannot be determined. In addition, since the sensitivity of the scintillator cannot be sufficiently improved only with a high orientation of crystals, there is a problem in that the sensitivity of the scintillator also depends on the concentration of thallium as an activator.

It is an object of the present invention to provide a radiological image detection apparatus having excellent sensitivity.

In order to solve the above-described problem, a radiological image detection apparatus of the present invention includes: a scintillator that has a plurality of columnar crystals and that converts a radiation into visible light and emits the visible light; and a photoelectric conversion panel that generates electric charges by detecting the visible light emitted from the scintillator. The scintillator contains cesium iodide and thallium, and a molar ratio of the thallium to the cesium iodide is in a range of 0.1 mol % to 0.55 mol % and a half width of a rocking curve of a (200) plane of the columnar crystal is equal to or less than 3°.

It is preferable that a thickness of the scintillator be 100 μm to 800 μm.

In addition, it is preferable that the photoelectric conversion panel be disposed so as to be closer to an incidence side of a radiation than the scintillator is. In this case, it is preferable to further include a support substrate that supports the scintillator, and it is preferable that the support substrate be disposed on a side of the scintillator not facing the photoelectric conversion panel.

In addition, it is preferable that the scintillator be formed on the support substrate by deposition and a distal end of the columnar crystal face the photoelectric conversion panel.

In addition, it is preferable to further include a surface protective film that covers a surface of the scintillator, and it is preferable that the distal end of the columnar crystal face the photoelectric conversion panel with the surface protective film interposed therebetween. In addition, it is preferable that the surface protective film be formed of poly-para-xylene.

In addition, it is preferable that an adhesive layer be formed on a surface of the photoelectric conversion panel and the scintillator be bonded to the photoelectric conversion panel with the adhesive layer interposed therebetween.

In addition, it is preferable to further include a substrate protective film formed on the support substrate, and it is preferable that the scintillator be formed on the substrate protective film. In addition, it is preferable that the surface protective film be formed of poly-para-xylene.

In addition, it is preferable that the half width of the rocking curve of the (200) plane of the columnar crystal be equal to or less than 2.5°. In addition, it is preferable that the molar ratio of the thallium to the cesium iodide be in a range of 0.2 mol % to 0.4 mol %.

According to the radiological image detection apparatus of the present invention, the excellent sensitivity can be obtained by setting the molar ratio of thallium to cesium iodide of the scintillator to be in a range of 0.1 mol % to 0.55 mol % and the half width of the rocking curve of the (200) plane of the columnar crystal to be equal to or less than 3°.

### BRIEF DESCRIPTION OF THE DRAWINGS

FIG. 1 is a partially broken perspective view of an X-ray image detection apparatus.

FIG. 2 is a schematic cross-sectional view of the X-ray image detection apparatus.

FIG. 3 is a schematic cross-sectional view showing the detailed configuration of a scintillator.

FIG. 4 is a circuit diagram showing the configuration of an element section of a photoelectric conversion panel.

FIG. 5 is a graph showing an X-ray diffraction spectrum by a θ-2θ method.

FIG. 6 is a graph showing an X-ray diffraction spectrum by a rocking curve method.

### DESCRIPTION OF THE PREFERRED EMBODIMENTS

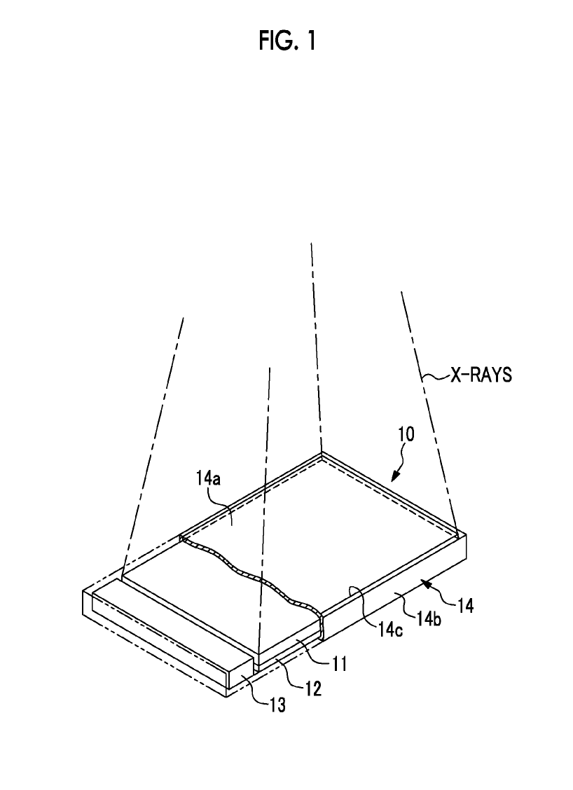

In FIG. 1, an X-ray image detection apparatus 10 is configured to include a flat panel detector (FPD) 11, a base 12, an electric circuit unit 13, and a housing 14 in which these are housed. The housing 14 has a top plate 14a and a flat and box-shaped main body 14b.

The top plate 14a seals an opening 14c formed in an upper portion of the main body 14b. The upper surface of the top plate 14a is an irradiation surface irradiated with X-rays that are emitted from an X-ray generator (not shown) and are transmitted through an imaging region of the subject (patient). For this reason, the top plate 14a is formed of carbon or the like having high X-ray transparency. The main body 14b is formed of ABS resin or the like.

Since the X-ray image detection apparatus 10 is portable similar to the conventional X-ray film cassette and can be used in place of the X-ray film cassette, the X-ray image detection apparatus 10 is called an electronic cassette.

In the housing 14, the FPD 11 and the base 12 are disposed in order from the top plate 14a side. The base 12 is fixed to the main body 14b of the housing 14. The FPD 11 is attached to the base 12. The electric circuit unit 13 is disposed on one end side along the lateral direction in the housing 14. A microcomputer or a battery (neither is shown in the drawing) is housed in the electric circuit unit 13.

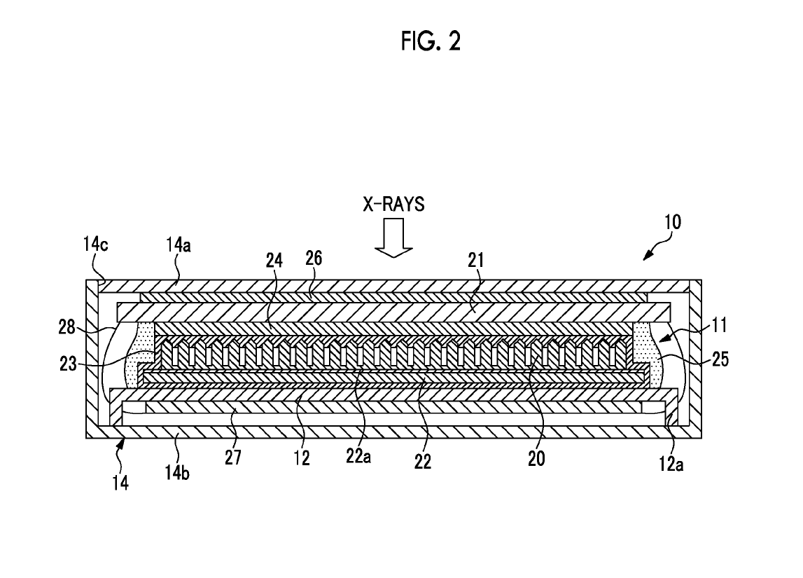

In FIG. 2, the FPD 11 has a scintillator 20 and a photoelectric conversion panel 21. The scintillator 20 is formed by depositing thallium-activated cesium iodide (CsI:Tl) on a support substrate 22, and has a columnar structure. For example, the support substrate 22 is formed of aluminum of about 300 μm in thickness.

A substrate protective film 22a is formed on the surface of the support substrate 22 on which the scintillator 20 is formed. For example, the substrate protective film 22a is formed of poly-para-xylene of about 10 μm in thickness. More specifically, parylene C (product name of Nippon Parylene Co. Ltd.; “parylene” is a registered trademark) is used as this poly-para-xylene.

In order to protect the scintillator 20 against moisture, a surface protective film 23 is formed on the entire surface of the scintillator 20 and the support substrate 22 exposed to the outside. For example, the surface protective film 23 is formed of poly-para-xylene of about 20 μm in thickness. More specifically, parylene C (product name of Nippon Parylene Co. Ltd.; “parylene” is a registered trademark) is used as this poly-para-xylene. The refractive index of the scintillator 20 is 1.81, and the refractive index of each of the substrate protective film 22a and the surface protective film 23 is 1.64.

The photoelectric conversion panel 21 is disposed on the top plate 14a side of the scintillator 20, and the photoelectric conversion panel 21 and the scintillator 20 are bonded to each other with an adhesive layer 24 interposed therebetween. The adhesive layer 24 is formed of transparent resin (for example, low-viscosity epoxy resin) to visible light, and has a thickness of about 15 μm, for example. In addition, side portions of the scintillator 20, the support substrate 22, and the adhesive layer 24 are covered by an end sealing material 25. The end sealing material 25 is formed of UV-curable resin. In addition, the photoelectric conversion panel 21 is bonded to the top plate 14a with an adhesive layer 26 interposed therebetween.

The base 12 is fixed to the bottom surface of the main body 14b through leg portions 12a. A circuit board 27 to perform driving, signal processing, and the like of the photoelectric conversion panel 21 is fixed to the surface of the base 12 not facing the scintillator 20. The circuit board 27 and the photoelectric conversion panel 21 are electrically connected to each other through a flexible cable 28.

The scintillator 20 generates visible light by absorbing X-rays that are transmitted through an imaging region and emitted to the top plate 14a and are then incident after being transmitted through the top plate 14a, the adhesive layer 26, the photoelectric conversion panel 21, the adhesive layer 24, and the surface protective film 23 The visible light generated by the scintillator 20 is incident on the photoelectric conversion panel 21 after being transmitted through the surface protective film 23 and the adhesive layer 24. The photoelectric conversion panel 21 converts the incident visible light into electric charges, and generates image data indicating a radiological image based on the electric charges.

Thus, the arrangement method, in which the photoelectric conversion panel 21 is disposed so as to be closer to the X-ray incidence side than the scintillator 20 is, is called an Irradiation Side Sampling (ISS) type.

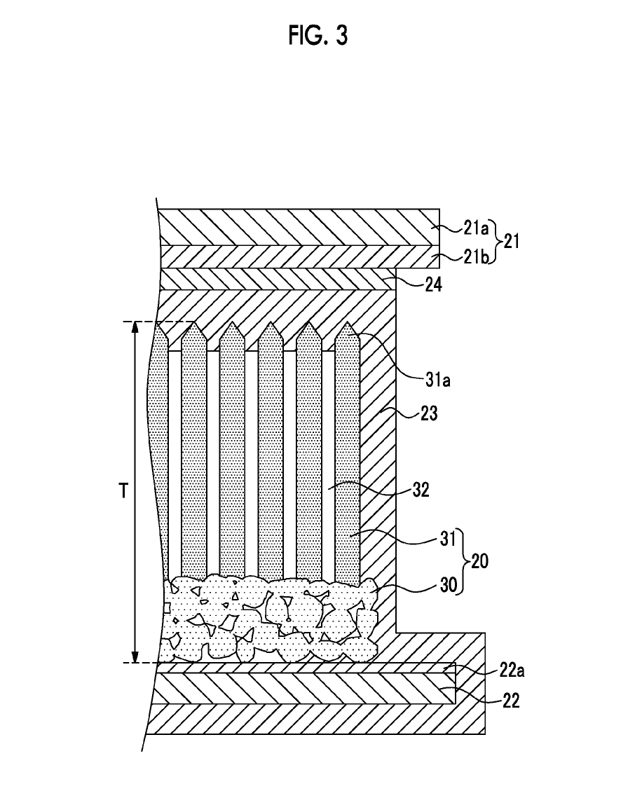

In FIG. 3, the scintillator 20 is configured to include a non-columnar crystal 30 and a columnar crystal 31. The non-columnar crystal 30 has a particle shape, and is formed on the entire support substrate 22. The columnar crystal 31 is formed on the non-columnar crystal 30 by crystal growth with the non-columnar crystal 30 as a base. The plurality of columnar crystals 31 are formed on the non-columnar crystal 30, and are separated from each other with an air layer 32 interposed therebetween. The diameter of the columnar crystal 31 is approximately uniform (about 6 μm) along the longitudinal direction.

Since X-rays are incident on the scintillator 20 from the photoelectric conversion panel 21 side, the generation of visible light within the scintillator 20 mainly occurs on the photoelectric conversion panel 21 side of the columnar crystal 31. The visible light generated in the scintillator 20 propagates through the columnar crystal 31 toward the photoelectric conversion panel 21 by the light guide effect of the columnar crystal 31, and is emitted from a distal end 31a toward the photoelectric conversion panel 21. The distal end 31a has an approximately conical shape, and the angle of the apex is an acute angle (for example, 40° to 80°).

The visible light generated in the columnar crystal 31 also propagates toward the support substrate 22 side by the light guide effect. The visible light propagating through the columnar crystal 31 toward the support substrate 22 side reaches the non-columnar crystal 30, and most of the visible light is reflected by the non-columnar crystal 30 and propagates toward the photoelectric conversion panel 21 side. For this reason, there is little loss of the visible light generated in the scintillator 20.

In the columnar crystal 31, the half width of the rocking curve of the (200) plane is equal to or less than 3°. It is preferable that the half width be equal to or less than 2.5°. More preferably, the half width is equal to or less than 2°. The rocking curve is an X-ray diffraction spectrum obtained by fixing a detector (not shown) at a position twice the angle, at which a specific crystal plane (in the present embodiment, a (200) plane) satisfies the Bragg's condition of diffraction, and changing the incidence angle of X-rays, and the smaller the value of the half width, the better the crystal quality. If the half width of the rocking curve of the (200) plane of the columnar crystal 31 is larger than 3°, there are many lattice defects. Accordingly, the scattering of visible light is large, and the sensitivity is reduced.

Since the FPD 11 is of an ISS type, the columnar crystal 31 having a small half width of the rocking curve of the (200) plane is disposed close to the photoelectric conversion panel 21, and the scattering of visible light in the vicinity of the photoelectric conversion panel 21 is small. Accordingly, the FPD 11 is more excellent in sensitivity than in the case of a Penetration Side Sampling (PSS) type. The PSS type is an arrangement method in which a photoelectric conversion panel is disposed so as to be closer to the opposite side to the X-ray incidence side than a scintillator is. In the PSS type, a non-columnar crystal is disposed close to the photoelectric conversion panel.

The thallium-activated cesium iodide to form the scintillator 20 is obtained by adding thallium (Tl) to cesium iodide (CsI) as an activator. It is preferable that the molar ratio of thallium to cesium iodide (hereinafter, referred to as a “Tl/CsI ratio”) be 0.1 mol % to 0.55 mol %. More preferably, the Tl/CsI ratio is 0.2 mo l% to 0.4 mol %. If this Tl/CsI ratio is smaller than 0.1 mol %, the sufficient emission intensity is not obtained. Accordingly, the sensitivity is reduced.

It is preferable that the thickness T of the scintillator 20 be equal to or greater than 100 μm and equal to or less than 800 μm. More preferably, the thickness T of the scintillator 20 is equal to or greater than 200 μm and equal to or less than 700 μm. If this thickness T is less than 100 μm, the sufficient emission intensity is not obtained since the amount of X-ray absorption is low. Accordingly, the sensitivity is reduced. On the other hand, if the thickness T is larger than 800 μm, attenuation or scattering of visible light in the scintillator 20 is large. Accordingly, the sensitivity is reduced.

The photoelectric conversion panel 21 is configured to include a glass substrate 21a and an element section 21b formed on the glass substrate 21a. The glass substrate 21a is disposed on the X-ray incidence side of the photoelectric conversion panel 21, and has a thickness of 700 μm, for example.

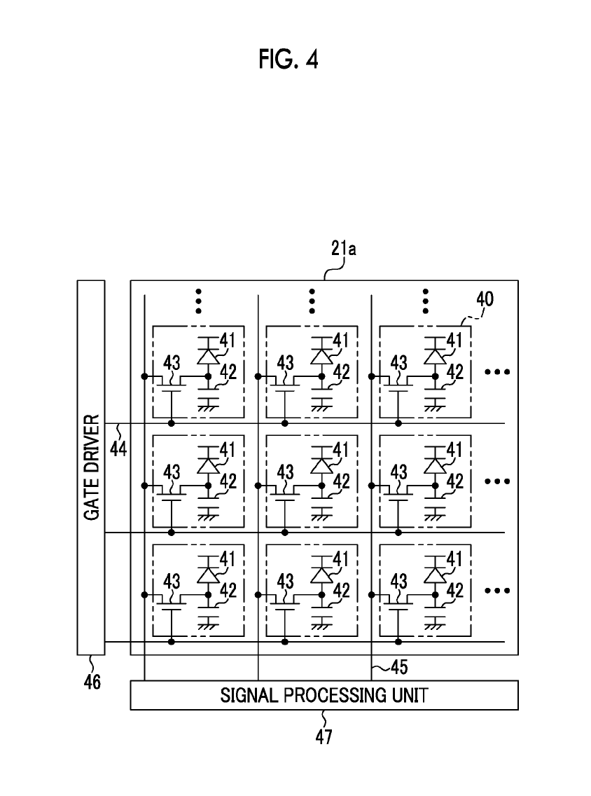

In FIG. 4, the element section 21b is formed by arraying a plurality of pixels 40 in a two-dimensional matrix. Each pixel 40 has a photodiode (PD) 41, a capacitor 42, and a thin film transistor (TFT) 43. The PD 41 is a photoelectric conversion element formed of amorphous silicon, and generates electric charges by absorbing visible light incident from the scintillator 20. The capacitor 42 stores the electric charges generated by the PD 41. The TFT 43 is a switching element for outputting the electric charges stored in the capacitor 42 to the outside of each pixel 40.

Each pixel 40 is connected to a gate line 44 and a data line 45. The gate line 44 extends in a row direction, and the plurality of gate lines 44 are arrayed in a column direction. The data line 45 extends in the column direction, and the plurality of data lines 45 are arrayed in the row direction so as to cross the gate lines 44. The gate line 44 is connected to the gate terminal of the TFT 43. The data line 45 is connected to the drain terminal of the TFT 43.

One end of the gate line 44 is connected to a gate driver 46. One end of the data line 45 is connected to a signal processing unit 47. The gate driver 46 and the signal processing unit 47 are provided in the circuit board 27. The gate driver 46 applies a gate driving signal sequentially to each gate line 44, thereby turning on the TFT 43 of the pixel 40 connected to each gate line 44. When the TFT 43 is turned on, electric charges stored in the capacitor 42 are output to the data line 45.

The signal processing unit 47 has an integrating amplifier (not shown) for each data line 45. The electric charges output to the data line 45 are integrated by the integrating amplifier and are converted into a voltage signal. In addition, the signal processing unit 47 has an A/D converter (not shown), and converts the voltage signal generated by each integrating amplifier into a digital signal to generate image data.

Next, a method of manufacturing the X-ray image detection apparatus 10 will be described. First, the substrate protective film 22a having a thickness of about 10 μm is formed by forming poly-para-xylene on the support substrate 22 formed of aluminum. The scintillator 20 is formed on the support substrate 22 with substrate protective film 22 interposed therebetween using a vapor deposition method.

Specifically, the support substrate 22 is put into the vacuum chamber (not shown) of a vapor deposition apparatus. This vacuum chamber includes two crucibles for heating cesium iodide (CsI) and thallium iodide (TlI), which are materials of the scintillator 20, separately. By opening the shutter of each crucible and adjusting the temperature of each crucible while rotating the support substrate 22 using a rotation mechanism of the vacuum chamber, the amount of evaporation of each material is adjusted to set a predetermined Tl/CsI ratio (for example, 0.5 mol %). In this case, the temperature of the support substrate 22 is controlled using a heater.

After the start of deposition, the non-columnar crystal 30 is first formed on the support substrate 22, and the columnar crystal 31 is formed continuously on the non-columnar crystal 30 by changing at least one of the degree of vacuum and the temperature of the support substrate 22. Then, the deposition is ended by stopping the heating of the crucible and the support substrate 22 by closing the shutter of each crucible when the thickness reaches the predetermined thickness T (for example, 400 μm).

The support substrate 22 formed with the scintillator 20 is taken out from the vacuum chamber. Then, the adhesive layer 24 is formed on the surface of the photoelectric conversion panel 21 on the element section 21b side, and the photoelectric conversion panel 21 and the scintillator 20 are bonded to each other so that the adhesive layer 24 faces the distal end 31a of the columnar crystal 31 of the scintillator 20 with the surface protective film 23 interposed therebetween. Finally, UV-curable resin is formed so as to cover the side portions of the scintillator 20, the support substrate 22, and the adhesive layer 24 and is cured by UV irradiation, thereby forming the end sealing material 25.

As described above, the FPD 11 is completed. By connecting the circuit board 27 to the FPD 11 through the flexible cable 28 and placing it in the housing 14 together with the electric circuit unit 13, the X-ray image detection apparatus 10 is completed.

Next, the operation in the present embodiment will be described. In order to capture a radiological image using the X-ray image detection apparatus 10, the radiographer (for example, a radiology technician) inserts the X-ray image detection apparatus 10 between the imaging region of the subject and the base (not shown) such that the top plate 14a faces the imaging region, and performs positioning.

After this positioning is completed, the radiographer gives an instruction to start radiographing by operating the console (not shown). In response to this instruction, X-rays are emitted from the X-ray generator (not shown), and the top plate 14a of the X-ray image detection apparatus 10 is irradiated with X-rays transmitted through the imaging region. The X-rays emitted to the top plate 14a are incident on the scintillator 20 after being transmitted through the top plate 14a, the adhesive layer 26, the photoelectric conversion panel 21, the adhesive layer 24, and the surface protective film 23.

The scintillator 20 generates visible light by absorbing the incident X-rays. The generation of visible light within the scintillator 20 mainly occurs on the top plate 14a side in the columnar crystal 31. The light generated in the columnar crystal 31 propagates through each columnar crystal 31, is emitted from the distal end 31a, is transmitted through the surface protective film 23 and the adhesive layer 24, and is incident on the element section 21b of the photoelectric conversion panel 21.

The visible light incident on the element section 21b is converted into electric charges for each pixel 40, and is output to the signal processing unit 47. The signal processing unit 47 converts each electric charge into a voltage signal, and converts the voltage signal into a digital signal to generate image data indicating a radiological image. The image data is transmitted to the console wirelessly or by cable, and an image based on the image data is displayed on a monitor (not shown) connected to the console.

In addition, although the FPD 11 is of the ISS type in the embodiment described above, the FPD 11 may be of the PSS type. When the FPD 11 is the PSS type, it is preferable to form the scintillator 20 directly on the photoelectric conversion panel 21 without using the support substrate 22.

### EXAMPLES

Hereinafter, the present invention will be specifically described through examples. However, the present invention is not limited to these examples.

### First Example

### 1. Formation of a Scintillator

One of the two crucibles in the vacuum chamber of the vapor deposition apparatus was filled with cesium iodide, and the other one was filled with thallium iodide. An aluminum substrate, which had a thickness of about 300 μm and had a surface on which poly-para-xylene was formed, was prepared as a support substrate, and was set in the vacuum chamber. The degree of vacuum was set to 0.5 Pa by flowing a certain amount of argon gas as process gas after exhausting the vacuum chamber to 5×10⁻³ Pa or less.

The deposition of the scintillator was started by heating each crucible and rotating the support substrate and opening the shutter of each crucible when the molten state of the material in the crucible was stabilized. In this case, the temperature of each crucible was adjusted so that the Tl/CsI ratio became 0.5 mol %. In addition, the temperature of the support substrate immediately after the start of deposition was set to 40° C. by controlling the temperature of the support substrate using a heater, and then the temperature of the support substrate was finally set to 120° C. by increasing the temperature gradually. In this manner, a non-columnar crystal was formed first, and a columnar crystal was grown continuously on this non-columnar crystal. The deposition was continued in this condition, and the heating of the crucible and the support substrate was stopped by closing the shutter of each crucible when the thickness of the scintillator reaches 400 μm. Then, the support substrate formed with the scintillator was taken out from the vacuum chamber.

### 2. Measurement of Crystallinity of the Scintillator

The crystallinity of the scintillator was evaluated using an X-ray diffractometer (X′Pert Pro of PANalytical Inc.). In this scintillator evaluation, the half width of the rocking curve of the (200) plane in the columnar crystal of the scintillator was measured based on the rocking curve method. The half width was measured as follows.

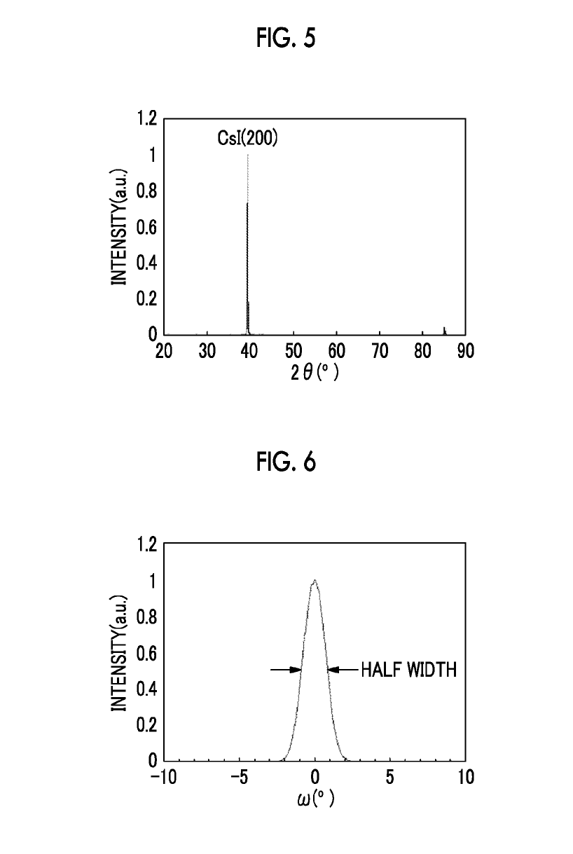

First, X-ray diffraction measurement was performed using a θ-2θ method, and a peak position derived from the (200) plane of CsI was calculated from the obtained X-ray diffraction spectrum (refer to FIG. 5). Then, an X-ray diffraction spectrum (rocking curve) having a mountain shape was acquired by fixing a detector of the X-ray diffractometer at an angle, at which the peak position was obtained, and changing the X-ray incidence angle ω to perform X-ray diffraction measurement (refer to FIG. 6). Then, the width (half width) of a position where the maximum intensity of the rocking curve became the half was calculated.

### 3. Manufacturing of the X-Ray Image Detection Apparatus

A photoelectric conversion panel was prepared, and an adhesive layer was formed on the surface of the photoelectric conversion panel by coating a low-viscosity epoxy resin agent diluted with a solvent (Araldite 2020 of Huntsman Corp.) using a spin coater so that the thickness after solvent dilution became 15 μm. In addition, poly-para-xylene was formed so as to cover the entire surface of the scintillator and the support substrate. Then, an FPD was manufactured by bringing a side of the photoelectric conversion panel, on which the adhesive layer was formed, into contact with the columnar crystal side of the scintillator and bonding the photoelectric conversion panel and the scintillator together by heating.

Then, the X-ray image detection apparatus of the first example was completed by attaching a circuit board, which performed driving, signal processing, and the like of the photoelectric conversion panel, to the photoelectric conversion panel through a flexible cable. Arrangement was performed so that X-rays are incident from the photoelectric conversion panel side (that is, the ISS type was adopted), and the detection of an X-ray image using the X-ray image detection apparatus was performed by connecting the FPD to the personal computer with a cable and controlling the FPD using the personal computer.

### 4. Measurement of the Sensitivity of the X-Ray Image Detection Apparatus

X-ray irradiation was performed on the X-ray image detection apparatus in order to drive the photoelectric conversion panel, electric charges stored in the PD were read by visible light generated in the scintillator and were amplified by the integrating amplifier, and then A/D conversion was performed to calculate the amount of generated electric charges. In addition, the amount of electric charges (noise of the detection system) when no X-rays were irradiated was measured in advance, and a value obtained by subtracting the measured amount of electric charges from the amount of generated electric charges of the amount of X-ray irradiation was set as the sensitivity.

### 5. Composition Evaluation of the Scintillator

The Tl/CsI ratio was calculated by dissolving a portion of the scintillator in water and quantifying the amount of cesium iodide and thallium using an inductively coupled plasma method.

### 6. Acceptability Determination

The sensitivity measured in this first example was set to 100, and the sensitivity in each of the following examples and comparative examples was expressed as relative sensitivity. It was assumed that the relative sensitivity equal to or greater than 100 was acceptable (Pass) and the relative sensitivity less than 100 was unacceptable (Fail).

### Second Example

An X-ray image detection apparatus of the second example was manufactured under the same conditions as in the first example except that the degree of vacuum of the vacuum chamber of the vapor deposition apparatus was set to 0.4 Pa and the final temperature of the support substrate under deposition was set to 110° C., and measurement and evaluation were performed. As a result, the relative sensitivity was 110, which was acceptable.

### Third Example

An X-ray image detection apparatus of the third example was manufactured under the same conditions as in the first example except that the degree of vacuum of the vacuum chamber of the vapor deposition apparatus was set to 0.3 Pa and the final temperature of the support substrate under deposition was set to 100° C., and measurement and evaluation were performed. As a result, the relative sensitivity was 120, which was acceptable.

### Fourth Example

An X-ray image detection apparatus of the fourth example was manufactured under the same conditions as in the second example except that the temperature of each crucible was adjusted so that the Tl/CsI ratio became 0.15 mol %, and measurement and evaluation were performed. As a result, the relative sensitivity was 105, which was acceptable.

### Fifth Example

An X-ray image detection apparatus of the fifth example was manufactured under the same conditions as in the second example except that the temperature of each crucible was adjusted so that the Tl/CsI ratio became 0.3 mol %, and measurement and evaluation were performed. As a result, the relative sensitivity was 115, which was acceptable.

### Sixth Example

An X-ray image detection apparatus of the sixth example was manufactured under the same conditions as in the fifth example except that deposition was performed until the thickness of the scintillator became 600 μm, and measurement and evaluation were performed. As a result, the relative sensitivity was 130, which was acceptable.

### Seventh Example

An X-ray image detection apparatus of the seventh example was manufactured under the same conditions as in the sixth example except that a scintillator was directly formed on the photoelectric conversion panel (that is, a PSS type FPD was used) without using a support substrate. As a result, the relative sensitivity was 110, which was acceptable.

Next, comparative examples for characteristic comparison with the X-ray image detection apparatuses of the first to seventh examples will be given.

### First Comparative Example

An X-ray image detection apparatus of the first comparative example was manufactured under the same conditions as in the fifth example except that the degree of vacuum of the vacuum chamber of the vapor deposition apparatus was set to 0.6 Pa and the final temperature of the support substrate under deposition was set to 140° C., and measurement and evaluation were performed. As a result, the relative sensitivity was 95, which was not acceptable.

### Second Comparative Example

An X-ray image detection apparatus of the second comparative example was manufactured under the same conditions as in the fifth example except that the degree of vacuum of the vacuum chamber of the vapor deposition apparatus was set to 0.7 Pa and the final temperature of the support substrate under deposition was set to 160° C., and measurement and evaluation were performed. As a result, the relative sensitivity was 85, which was not acceptable.

### Third Comparative Example

An X-ray image detection apparatus of the third comparative example was manufactured under the same conditions as in the second example except that the temperature of each crucible was adjusted so that the Tl/CsI ratio became 0.05 mol %, and measurement and evaluation were performed. As a result, the relative sensitivity was 95, which was not acceptable.

### Fourth Comparative Example

An X-ray image detection apparatus of the fourth comparative example was manufactured under the same conditions as in the second example except that the temperature of each crucible was adjusted so that the Tl/CsI ratio became 0.6 mol %, and measurement and evaluation were performed. As a result, the relative sensitivity was 95, which was not acceptable.

### Fifth Comparative Example

An X-ray image detection apparatus of the fifth comparative example was manufactured under the same conditions as in the second comparative example except that deposition was performed until the thickness of the scintillator became 600 μm, and measurement and evaluation were performed. As a result, the relative sensitivity was 90, which was not acceptable.

The measurement and evaluation results of the first to seventh examples and the first to fifth comparative examples are shown in Table 1.

TABLE 1

| | | | | Half width | | |
|---|---|---|---|---|---|---|
| | | | | of rocking | | |
| | | Thickness | Tl/Cs ratio | curve of | Relative | Acceptability |
| | FPD type | (μm) | (mol %) | (200) plane | sensitivity | determination |
| First | ISS | 400 | 0.5 | 2.8 | 100 | Pass |
| example | | | | | | |
| Second | ISS | 400 | 0.5 | 2.4 | 110 | Pass |
| example | | | | | | |
| Third | ISS | 400 | 0.5 | 2.0 | 120 | Pass |
| example | | | | | | |
| Fourth | ISS | 400 | 0.15 | 2.3 | 105 | Pass |
| example | | | | | | |
| Fifth | ISS | 400 | 0.3 | 2.3 | 115 | Pass |
| example | | | | | | |
| Sixth | ISS | 600 | 0.3 | 2.1 | 130 | Pass |
| example | | | | | | |
| Seventh | PSS | 600 | 0.3 | 2.1 | 110 | Pass |
| example | | | | | | |
| First | ISS | 400 | 0.3 | 3.9 | 95 | Fail |
| comparative | | | | | | |
| example | | | | | | |
| Second | ISS | 400 | 0.3 | 6.5 | 85 | Fail |
| comparative | | | | | | |
| example | | | | | | |
| Third | ISS | 400 | 0.05 | 2.3 | 95 | Fail |
| comparative | | | | | | |
| example | | | | | | |
| Fourth | ISS | 400 | 0.6 | 2.9 | 95 | Fail |
| comparative | | | | | | |
| example | | | | | | |
| Fifth | ISS | 600 | 0.3 | 5.8 | 90 | Fail |
| comparative | | | | | | |
| example | | | | | | |

From Table 1, it can be seen that the higher sensitivity than that in the first to fifth comparative examples can be obtained by setting the half width of the rocking curve of the (200) plane to be equal to or less than 3° and the Tl/CsI ratio to be within the range of 0.1 mol % to 0.55 mol % as in the first to seventh examples. In addition, when the fifth and sixth examples are compared, it can be seen that the sensitivity is improved as the thickness of the scintillator increases. In addition, when the sixth and seventh examples are compared, it can be seen that the sensitivity in the case of the ISS type is more improved than that in the case of the PSS type. In addition, when the fifth example and the second comparative example and the sixth example and the fifth comparative example are compared, it can be seen that the sensitivity is noticeably improved when the half width of the rocking curve of the (200) plane is small.

In addition, although the present invention is applied to the electronic cassette, which is a portable radiological image detection apparatus, in the embodiment described above, the present invention may also be applied to a standing or sitting type radiological image detection apparatus, a mammographic apparatus, and the like.

What is claimed is:

1. A radiological image detection apparatus comprising:
a scintillator that has a plurality of columnar crystals and that converts a radiation into visible light and emits the visible light; and
a photoelectric conversion panel that generates electric charges by detecting the visible light emitted from the scintillator,
wherein the scintillator contains cesium iodide and thallium, and a molar ratio of the thallium to the cesium iodide is in a range of 0.1 mol % to 0.55 mol % and a half width of a rocking curve of a (200) plane of the columnar crystal is equal to or less than 3°.

2. The radiological image detection apparatus according to claim 1,
wherein a thickness of the scintillator is 100 μm to 800 μm.

3. The radiological image detection apparatus according to claim 1,
wherein the photoelectric conversion panel is disposed so as to be closer to an incidence side of a radiation than the scintillator is.

4. The radiological image detection apparatus according to claim 2,
wherein the photoelectric conversion panel is disposed so as to be closer to an incidence side of a radiation than the scintillator is.

5. The radiological image detection apparatus according to claim 3, further comprising:
a support substrate that supports the scintillator,
wherein the support substrate is disposed on a side of the scintillator not facing the photoelectric conversion panel.

6. The radiological image detection apparatus according to claim 4, further comprising:
a support substrate that supports the scintillator,
wherein the support substrate is disposed on a side of the scintillator not facing the photoelectric conversion panel.

7. The radiological image detection apparatus according to claim 5,
wherein the scintillator is formed on the support substrate by deposition, and a distal end of the columnar crystal faces the photoelectric conversion panel.

8. The radiological image detection apparatus according to claim 6,
wherein the scintillator is formed on the support substrate by deposition, and a distal end of the columnar crystal faces the photoelectric conversion panel.

9. The radiological image detection apparatus according to claim 7, further comprising:
a surface protective film that covers a surface of the scintillator,
wherein the distal end faces the photoelectric conversion panel with the surface protective film interposed between the distal end and the photoelectric conversion panel.

10. The radiological image detection apparatus according to claim 8, further comprising:
a surface protective film that covers a surface of the scintillator,
wherein the distal end faces the photoelectric conversion panel with the surface protective film interposed between the distal end and the photoelectric conversion panel.

11. The radiological image detection apparatus according to claim 9,
wherein the surface protective film is formed of poly-para-xylene.

12. The radiological image detection apparatus according to claim 10,
wherein the surface protective film is formed of poly-para-xylene.

13. The radiological image detection apparatus according to claim 11,
wherein an adhesive layer is formed on a surface of the photoelectric conversion panel, and the scintillator is bonded to the photoelectric conversion panel with the adhesive layer interposed between the scintillator and the photoelectric conversion panel.

14. The radiological image detection apparatus according to claim 12,
wherein an adhesive layer is formed on a surface of the photoelectric conversion panel, and the scintillator is bonded to the photoelectric conversion panel with the adhesive layer interposed between the scintillator and the photoelectric conversion panel.

15. The radiological image detection apparatus according to claim 13, further comprising:
a substrate protective film formed on the support substrate,
wherein the scintillator is formed on the substrate protective film.

16. The radiological image detection apparatus according to claim 14, further comprising:
a substrate protective film formed on the support substrate,
wherein the scintillator is formed on the substrate protective film.

17. The radiological image detection apparatus according to claim 15,
wherein the surface protective film is formed of poly-para-xylene.

18. The radiological image detection apparatus according to claim 16,
wherein the surface protective film is formed of poly-para-xylene.

19. The radiological image detection apparatus according to claim 1,
wherein the half width of the rocking curve of the (200) plane of the columnar crystal is equal to or less than 2.5°.

20. The radiological image detection apparatus according to claim 1,
wherein the molar ratio of the thallium to the cesium iodide is in a range of 0.2 mol % to 0.4 mol %.
